(19) United States
(12) Patent Application Publication
(10) Pub. No.: US 2003/0065074 A1
(43) Pub. Date: Apr. 3, 2003

(54) Colored thermoplastic resin compositions for laser welding anthraquinone colorants therefor and molded product therefrom

(76) Inventors: Reiko Koshida, Utsunomiya (JP); Yoshiteru Hatase, Osaka (JP); Ryuichi Hayashi, Tokyo (JP); Hiroyuki Sumi, Tochigi-ken (JP)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/047,731

(22) Filed: Apr. 26, 2002

Related U.S. Application Data
(60) Provisional application No. 60/247,937, filed on Nov. 13, 2000.

(51) Int. Cl. C08K 5/08

(52) U.S. Cl. 524/358

(57) ABSTRACT

Thermoplatic resin compositions suitable for laser welding are discribed in which black colorants are added. These colorants constitute amine salt of anthraquinone dyes. Additional dyes, coloring agents, and a variety of other materials may be added. These compositions demonstrate outstanding mechanical and chemical properties once laser-welded.

This application claims the benefit of U.S. Provisional Application No. 60/247,937, filed Nov. 13, 2000.

### FIELD OF THE INVENTION

The instant invention relates to thermoplastic resin compositions containing black colorants and suitable for laser welding. More particularly, the invention relates to such compositions having improved laser weldability and mechanical properties.

### BACKGROUND OF THE INVENTION

It is known in the art to join together two articles made of resins (and respectively opaque and transparent) by positioning them in contact with each other, transmitting a predetermined amount of laser beam focused on the junction of them and causing the junction portion to be melted and joined together (“laser welding”). Several advantages flow from laser welding versus conventional methods of joining plastic parts. For example, laser welding is widely known for its simple operation, labor savings, improvement of productivity, clear joints, and reduction of production cost. It is useful in various applications including the preparation of molded articles, including hollow shapes, in automobile industries and electric and electronic industries. Recently, work has intensified in the area of blends of thermoplastic resin and a colorant containing an organic dye or pigment. Better control of the conversion of laser energy to heat is achieved by the addition of such colorants to the resins. Laser beams penetrate through transparent articles positioned closer to the laser beam source, and are largely absorbed in the opaque article, which has a relatively higher absorption coefficient in comparison with the aforementioned transparent article. Careful attention to the amount of the colorants therein results in the junction portion being melted and the articles joined together.

See for example Japanese Published (Koukoku) Patent No. 62-49850 and Japanese Published (Koukoku) Patent No.5 (93)-42336. Other resin compositions associated with the laser welding are described in U.S. Pat. No. 5,893,959 which discloses transparent and opaque workpiece parts welded together by a laser beam along a joining zone. Both parts contain black dye pigments such as carbon black to cause them to offer a substantially homogenous visual impression even after welding.

Other illustrations of the laser welding of compositions are found in U.S. Pat. No. 5,893,959. For example, the color of the thermoplastic components may be black (carbon black or nigrosine) which is commonly and widely used in the automobile industry among other applications. However, carbon black and X nigrosine cannot transmit a laser beam with a main wavelength in the infra-red region (1200 nm to 800 nm), such as Nd:YAG laser and a diode laser, both of which are of wide use in industries.

Surprisingly, it has now been found that thermoplastic resin compositions both black in appearance can be used for laser-welded molded articles for both the transparent and opaque parts subjected to the laser beam. A significantly improved transmission to near-infrared light of the laser beam, with excellent and balanced heat-resistance and mechanical properties as required in automobile applications, is achieved by including a specific weight percentage of black dyes comprising amine salt of anthraquinone dyes.

Using these components, thermoplastic resin compositions can be utilized for laser welding and exhibiting improvements in moldability, solubility in the thermoplastic resin, bleeding- and blooming-resistance as well as transparency to the wavelength of a laser beam and resistance to chemicals.

### SUMMARY OF THE INVENTION

There is disclosed and claimed herein thermoplastic resin compositions for laser welding comprising thermoplastic resin and laser-transmitting black colorant comprising amine salt of anthraquinone dye. More particularly, this black colorant comprises amine salt of anthraquinone dyes of formula [I], or formula [II], wherein

Formula[I] is:

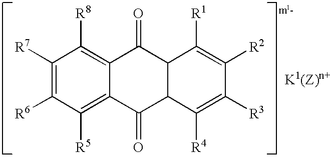

wherein R¹ to R⁸, which may be the same or different, are independently selected from the group consisting of H, alkyl, aryl, alkenyl, alkoxy, amino, hydroxy, halogen atom, acyl, acyloxy, acylamide, acyl-N-alkylamide, carboxyl, alkoxycarbonyl, cyclohexylamide, sulfonyl, formula [I-a], or —Y-W; and at least one of R¹ to R⁸ is of formula [I-a]; wherein Y is S, O, or NH, and W is selected from unsubstituted or substituted alkyl group, alkenyl group, and unsubstituted or substituted aryl group, wherein (Z)ⁿ⁺ represents ammonium ion or a cation derived from an organic amine compounds or a basic dye wherein n is 1 or 2, ml is an integer from 1 to 4 and K¹ is the ratio of m¹/n; formula [I-a] is:

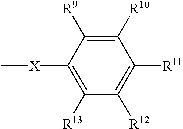

wherein X is O or NH, and R⁹ to R¹³, which may be the same or different, are independently selected from the group consisting of H, alkyl, aryl, alkenyl, alkoxy, amino, N-alkylamide, N-arylamide, hydroxy, halogen atom, acyl, acyloxy, acylamide, acyl-N-alkylamide, carboxyl, alkoxycarbonyl, or sulfonyl. In the above, at least one of R¹ to R⁸ and R⁹ to R¹³ is sulfonyl group.

Formula [II] is:

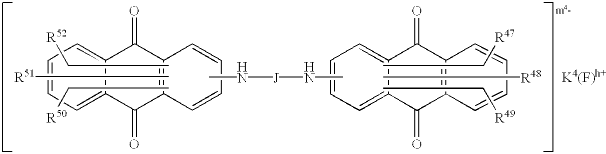

wherein R⁴⁷ to R⁵², which may be the same or different, are independently selected from the group consisting of H, alkyl, aryl, alkenyl, alkoxy, amino, N-alkylamide, N-arylamide, hydroxy, halogen atom, acyl, acyloxy, acylamide, acyl-N-alkylamide, carboxyl, alkoxycarbonyl, or sulfonyl, and at least one of R⁴⁷ to R⁵² is of sulfonyl. (F)^{h+} represents ammonium ion or a cation derived from an organic amino compounds or a basic dye wherein h is 1 or 2, m⁴ is an integer from 1 to 4 and K⁴ is the ratio of m⁴/h.

Formula J in formula [II] is selected from formula [II-a] or formula [11-b] and binds two anthraquinone.

fomula [II-a]:

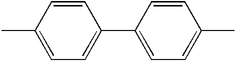

formula [II-b]:

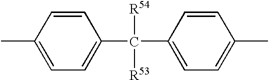

wherein R⁵³ to R⁵⁴, which may be the same or different, are independently selected 50 from the group consisting of alkyl(having 1 to 8 carbon atoms) or hydrogen.

The amine salt of anthraquinone dyes used as colorants in the invention exhibit colors of red, blue, violet and green. It is possible to obtain black shades by mixing the dye salts mentioned above with red dyes such as perinone dyes and/or yellow dyes or monoazo metal complex dyes or anthrapyridone dyes at predetermined weight ratios.

### BRIEF DESCRIPTION OF THE DRAWINGS

The invention will be better understood upon having reference to the drawings herein.

FIG. 1 is a view of the articles in contact and with a laser beam applied thereto;

FIG. 2 is identical to FIG. 1, but with articles of the same color.

FIG. 3 is a side view of articles positioned for a laser welding test;

FIG. 4 is a top view of articles positioned for a laser welding test;

FIG. 5 is both a side view and a top view of a test piece used in the laser welding test; and

FIG. 6 is a side view of the test piece moved into position for the laser welding test.

### DETAILED DESCRIPTION OF THE INVENTION

The dye salts of the desired structure represented by formula [I] or formula [II] used in the invention and described above are prepared by commonly known methods, as is readily appreciated by those having skill in the art. One convenient technique is to react anthraquinone dyestuff with organic amine in a solvent. Formula [I] or formula [II] reacted by this way has good transmittance in a main laser beam wavelength (1200 nm to 800 nm).

Basic dyes listed in the color index and useful in the instant invention include, C.I.basic red dye: C.I.basic red1, 2, 3, 4, 5, 6, 8, 9, 10, 11, 12, 13, 15, 16, 17, 19, 20,26,27,35,36,37,48,49,52,53,54,66,68, C.I.basic blue dye: C.I.basic blue 1, 2, 3, 4, 5, 6, 7, 8, 9, 10, 11, 12, 13, 14, 15, 18, 20,21,22,23,24,25,26,35,36,37,45,46,47,49,50,55,56,60,62,67,75,77, 79,80,81,83,87,88,89,90,94,95,96,97,

C.T.basic violet dye: C.I.basic violet 1, 2, 3, 4, 5, 6, 7, 8, 10, 11, 12, 13, 14, 15, 16, 17,20,21,23,24,25,27,40,

C.I.basic green dye: C.I.basic green 1, 3, 4, 6, 9, 10, 5

Suitable amines for use in producing the above-mentioned anthraquinone dyes in dyestuffs and/or capable of salt formation in dyestuffs include aliphatic amine, alicyclic amine, alkoxyalkyl amine, amine having alkanol, diamine, amine of guanidine derivatives, and aromatic amine.

Examples of anthraquinone acid dyes which are useful in preparation of the dye salts of formula [I] used as colorants in the compositions of the invention are given below in Tables 1-1 and 1-2. Designations in the left hand column (such as “I-2” and “I-13”) will assist the reader in understanding discussions about specific dye salts later in the description.

TABLE 1-1

| Pro. | | |
|---|---|---|
| Ex. | | |
| No. | R¹,R²,R³,R⁴,R⁵,R⁶,R⁷,R⁸ | K¹(Z)ⁿ⁺ |
| I-1 | R²═R⁵═R⁶═R⁷═R⁸═H,R⁴═OH,R¹═R³═I-a, | Rosin anmmonium |
| | Formula[I-a]:X═NH,R¹¹═NO_{2,}R⁹═SO₃H or SO₃⁻, | |
| | R¹⁰═R¹²═R¹³═H | |
| I-2 | R²═R³═R⁵═R⁶═R⁷═R⁸═H,R⁴═OH,R¹═I-a, | H₃N⁺(CH₂)₆NH₂ |
| | Formula[I-a]:X═NH,R¹¹═CH₃, | |
| | R⁹═SO₃⁻,R¹⁰═R¹²═R¹³═H | |
| I-3 | R²═R³═R⁵═R⁶═R⁷═R⁸═H,R¹═I-a,R⁴═Y-W, | C₁₂H₂₅N⁺H₃ |
| | Formula[I-a]:X═NH,R¹¹═CH₃, | |
| | R⁹═SO₃⁻,R¹⁰═R¹²═R¹³═H | |
| | Y-W:Y═NH,W═CH₃ | |
| I-4 | R²═R³═R⁵═R⁶═R⁷═R⁸═H,R¹═R⁴═I-a, | (C₄H₉)₄N⁺ |
| | Formula[I-a]:X═NH,R¹¹═CH₃,R⁹═SO₃H or SO₃⁻, | |
| | R¹⁰═R¹²═R¹³═H | |
| I-5 | R²═R³═R⁵═R⁶═R⁷═R⁸═H,R¹═R⁴═I-a, | H₃N⁺(CH₂)₆NH₂ |
| | Formula[I-a]:X═NH,R⁹═R¹¹═R¹³═CH₃,R¹²═SO₃H | |
| | or SO₃⁻,R¹⁰═H | |
| I-6 | R²═R³═R⁵═R⁶═R⁷═R⁸═H,R¹═R⁴═I-a, | (N⁺H₃)₂CNH |
| | Formula[I-a]:X═NH,R¹¹═CH₃, | |
| | R⁹═SO₃⁻,R¹⁰═R¹²═R¹³═H | |
| I-7 | R²═R³═R⁵═R⁶═R⁷═R⁸═H,R¹═R⁴═I-a, | H₃N⁺(CH₂)₆NH₂ |
| | Formula[I-a]:X═NH,R¹¹═C₄H₉,R⁹═SO₃H or SO₃⁻, | |
| | R¹⁰═R¹²═R¹³═H | |
| I-8 | R²═R³═R⁵═R⁷═R⁸═H,R¹═R⁴═I-a,R⁶═Y-W, | H₃N⁺(CH₂)₄NH₂ |
| | Formula[I-a]:X═NH,R¹¹═CH₃,R⁹═SO₃H or SO₃⁻, | |
| | R¹⁰═R¹²═R¹³═H | |
| | Y-W:Y═S,W═methylphenyl | |
| I-9 | R²═R³═R⁵═R⁶═R⁷═R⁸═H,R¹═R⁴═I-a, | 2(H₃N⁺(CH₂)₆NH₂) |
| | Formula[I-a]:X═NH,R¹¹═C₄H₉,R⁹═SO₃⁻, | |
| | R¹⁰═R¹²═R¹³═H | |
| I-10 | R²═R⁵═R⁶═R⁷═R⁸═H,R³═SO₃⁻, | N-trimethyl-N-benzyl |
| | R⁴═NH₂,R¹═I-a, | Anmmonium |
| | Formula[I-a]:X═NH,R¹¹═N(C₃H₇)COCH₃, | |
| | R⁹═R¹⁰═R¹²═R¹³═H | |
| I-11 | R²═R⁵═R⁷═R⁸═H,R³═R⁶═SO₃⁻, | 2(CH₃)₄N⁺ |
| | R⁴═NH₂,R¹═I-a, | |
| | Formula[I-a]:X═NH,R¹¹═NHCOCH₃, | |
| | R⁹═R¹⁰═R¹²═R¹³═H | |
| I-12 | R²═R³═R⁵═R⁶═R⁷═R⁸═H,R¹═R⁴═I-a, | Diphenylguanidine |
| | Formula[I-a]:X═NH,R⁹═R¹¹═R¹³═CH₃,R¹²═SO₃H | anmmonium |
| | or SO₃⁻,R¹⁰═H | |
| I-13 | R²═R³═R⁵═R⁶═R⁷═R⁸═H,R¹═R⁴═I-a, | Bis(p-methylphenyl) |
| | Formula[I-a]:X═NH,R¹¹═CH₃,R⁹═SO₃H or SO₃⁻, | guanidine |
| | R¹⁰═R¹²═R¹³═H | anmmonium |
| I-14 | R²═R³═R⁴═R⁵═R⁶═R⁷═H,R¹═R⁸═I-a, | C₁₂H₂₅N⁺H₃ |
| | Formula[I-a]:X═NH,R¹¹═CH₃,R⁹═SO₃H or SO₃⁻, | |
| | R¹⁰═R¹²═R¹³═H | |
| I-15 | R⁵═R⁶═R⁷═R⁸═H,R¹═R⁴═NH_{2,} | (CH₃)₄N⁺ |
| | R²═R³═I-a, | |
| | Formula[I-a]:X═O,R¹¹═CH₃,R⁹═SO₃H or SO₃⁻, | |
| | R¹⁰═R¹²═R¹³═H | |

Pro. Ex. No. = Product Example Number

TABLE 1-2

| Pro. | | |
|---|---|---|
| Ex. | | |
| No. | R¹,R²,R³,R⁴,R⁵,R⁶,R⁷,R⁸ | K¹(Z)ⁿ⁺ |
| I-16 | R⁵═R⁶═R⁷═R⁸═H,R¹═R⁴═NH₂,R²═R³═I-a, | H₃N⁺(CH₂)₆NH₂ |
| | Formula[I-a]:X═O,R¹¹═SO₃H or SO₃⁻, | |
| | R⁹═R¹⁰═R¹²═R¹³═H | |
| I-17 | R³═R⁶═R⁷═R⁸═H,R²═CH₃,R⁴═NH₂, | C₄H₉N⁺H₃ |
| | R⁵═SO₃H or SO₃⁻,R¹═I-a, | |
| | Formula[I-a]:X═NH,R¹¹═CH₃,R⁹═SO₃H or SO₃⁻, | |
| | R¹⁰═R¹²═R¹³═H | |
| I-18 | R³═R⁶═R⁷═R⁸═H,R²═Br,R⁴═NH₂, | H₃N⁺(CH₂)₄NH₂ |
| | R⁵═SO₃H or SO₃⁻,R¹═I-a, | |
| | Formula[I-a]:X═NH,R¹¹═CH₃,R⁹═SO₃H or SO₃⁻, | |
| | R¹⁰═R¹²═R¹³═H | |
| I-19 | R²═R⁶═R⁷═R⁸═H,R³═OC₁₂,H₂₅,R⁴═NH₂, | C₂H₅OC₃H₆N⁺H₃ |
| | R⁵═SO₃H or SO₃⁻,R¹═I-a, | |
| | Formula[I-a]:X═NH,R¹¹═SO₃H or SO₃⁻, | |
| | R⁹═R¹⁰═R¹²═R¹³═H | |
| I-20 | R²═R³═R⁶═R⁷═HR⁴═R⁸═OH,R¹═R⁵═I-a, | (C₈H₁₇)₄N⁺ |
| | Formula[I-a]:X═NH,R¹¹═CH₃,R⁹═SO₃H or SO₃⁻, | |
| | R¹⁰═R¹²═R¹³═H | |
| I-21 | R²═R³═R⁵═R⁶═R⁷═R⁸═H,R¹═R⁴═I-a, | 2(H₃N⁺(CH₂)₆NH₂) |
| | Formula[I-a]:X═NH,R⁹═R¹¹═R¹³═CH₃,R¹²═SO₃⁻, | |
| | R¹⁰═H | |
| I-22 | R²═R⁵═R⁶═R⁷═R⁸═H,R³═SO₃⁻,R⁴═NH₂, | C₄H₉N⁺H₃ |
| | R¹═I-a, | |
| | Formula[I-a]:X═NH,R¹¹═NHCOCH₃, | |
| | R⁹═R¹⁰═R¹²═R¹³═H | |
| I-23 | R²═R³═R⁵═R⁶═R⁷═R⁸═H,R¹═R⁴═I-a, | H₃N⁺(CH₂)₆NH₂ |
| | Formula[I-a]:X═NH,R¹¹═CH₃,R⁹═SO₃H or SO₃⁻, | |
| | R¹⁰═R¹²═R¹³═H | |
| I-24 | R²═R³═R⁴═R⁵═R⁶═R⁷═H,R¹═R⁸═I-a, | C₂H₅OC₃H₆N⁺H₃ |
| | Formula[I-a]:X═NH,R¹¹═CH₃,R⁹═SO₃H or SO₃⁻, | |
| | R¹⁰═R¹²═R¹³═H | |
| I-25 | R²═R⁵═R⁶═R⁷═R⁸═H,R³═SO₃⁻, | H₃N⁺(CH₂)₆NH₂ |
| | R⁴═NH₂,R¹═I-a, | |
| | Formula[I-a]:X═NH,R¹¹═NHCOCH₃, | |
| | R⁹═R¹⁰═R¹²═R¹³═H | |
| I-26 | R²═R⁵═R⁶═R⁷═R⁸═H,R³═SO₃⁻,R⁴═NH₂, | Cyclohexyl |
| | R¹═I-a, | anmmonium |
| | Formula[I-a]:X═NH,R¹¹═N(CH₃)COCH₃, | |
| | R⁹═R¹⁰═R¹²═R¹³═H | |
| I-27 | R²═R³═R⁵═R⁶═R⁷═R⁸═H,R¹═R⁴═I-a, | C₂H₅OC₃H₆N⁺H₃ |
| | Formula[I-a]:X═NH,R⁹═R¹¹═R¹³═CH₃,R¹²═SO₃H | |
| | or SO₃⁻,R¹⁰═H | |
| I-28 | R²═R³═R⁵═R⁶═R⁷═R⁸═H,R⁴═OH,R¹═I-a, | H₃N⁺(CH₂)₆NH₂ |
| | Formula[I-a]:X═NH,R¹¹═CH₃, | |
| | R⁹═SO₃⁻,R¹⁰═R¹²═R¹³═H | |
| I-29 | R²═R⁵═R⁶═R⁷═R⁸═H,R³═SO₃⁻, | N-trimethyl-N-benzyl |
| | R⁴═NH₂,R¹═I-a, | Anmmonium |
| | Formula[I-a]:X═NH,R¹¹═N(CH₃)COCH₃, | |
| | R⁹═R¹⁰═R¹²═R¹³═H | |
| I-30 | R³═R⁵═R⁶═R⁷═R⁸═H,R¹═R⁴═OH,R²═I-a, | N-tributhyl-N-benzyl |
| | Formula[I-a]:X═NH,R⁹═CH₃, | anmmonium |
| | R¹¹═SO₃⁻,R¹⁰═R¹²═R¹³═H | |
| I-31 | R⁵═R⁶═R⁷═R⁸═H,R¹═R⁴═NH₂,R³═SO₃⁻,R²═I-a, | C₄H₉N⁺H₃ |
| | Formula[I-a]:X═O,R⁹═R¹⁰, | |
| | R¹¹═R¹²═R¹³═H | |
| I-32 | R³═R⁶═R⁷═R⁸═H,R⁴═NH₂, | Benzylurea |
| | R²═R⁵═SO₃H or SO₃⁻,R¹═I-a, | anmmonium |
| | Formula[I-a]:X═NH,R¹¹═C₁₂,H₂₅, | |
| | R⁹═R¹⁰═R¹²═R¹³═H | |
| I-33 | R²═R⁵═R⁶═R⁷═R⁸═H,R³═SO₃⁻,R⁴═NH₂, | H₃N⁺(CH₂)₆NH₂ |
| | R¹═I-a, | |
| | Formula[I-a]:X═NH,R¹⁰═COOC₂H_{5,} | |
| | R⁹═R¹¹═R¹²═R¹³═H | |

Pro. Ex. No. = Product Example Number

Examples of anthraquinone acid dyes which are useful in preparation of the dye salts of formula [II] used as colorant comprised in the compositions of the invention are given in Table 2 below.

TABLE 2

| Pro. | | | | | | | | |
|---|---|---|---|---|---|---|---|---|
| Ex. | | | | | | | | |
| No. | J | R⁴⁷ | R⁴⁸ | R⁴⁹ | R⁵⁰ | R⁵¹ | R⁵² | K⁴(F)^{h+} |
| II-1 | Fomula[II-a] | SO₃⁻ | NH₂ | H | SO₃⁻ | NH₂ | H | 2(H₃N⁺(CH₂)₆NH₂) |
| II-2 | fomula[II-a] | SO₃⁻ | NH₂ | H | SO₃H | NH₂ | H | H₃N⁺(CH₂)₆NH₂ |
| II-3 | fomula[II-a] | SO₃⁻ | OH | H | SO₃H | OH | H | C₁₂H₂₅N^{+H}₃ |
| II-4 | Formula[II-b], | SO₃⁻ | NH₂ | H | NH₂ | Cl | H | C₂H₅OC₃H₆N⁺H₃ |
| | R⁵³═R⁵⁴═H | | | | | | | |
| II-5 | formula[II-b], | SO₃⁻ | NH₂ | H | SO₃H | NH₂ | H | Bis(p-methylphenyl) |
| | R⁵³═R⁵⁴═CH₃ | | | | | | | guanidine |
| | | | | | | | | anmmonium |
| II-6 | formula[II-b], | SO₃⁻ | NH₂ | H | SO₃⁻ | NH₂ | H | H₃N⁺(CH₂)₄N⁺H₃ |
| | R⁵³═R⁵⁴═CH₃ | | | | | | | |
| II-7 | formula[II-b], | SO₃⁻ | NH₂ | H | SO₃H | NH₂ | H | Rosin anmmonium |
| | R⁵³═R⁵⁴═H | | | | | | | |
| II-8 | formula[II-b], | SO₃⁻ | NH₂ | H | SO₃H | NH₂ | H | H₃N⁺(CH₂)₆NH₂ |
| | R⁵³═R⁵⁴═H | | | | | | | |
| II-9 | formula[II-b], | SO₃⁻ | OH | OCH₃ | SO₃H | OH | OCH₃ | (C₄H₉)₄N⁺ |
| | R⁵³═H, | | | | | | | |
| | R⁵⁴═phenyl | | | | | | | |
| II-10 | formula[II-b], | SO₃⁻ | C₃H₉ | C₃H₉ | SO₃H | H | H | N-tributhyl-N-benzyl |
| | R⁵³═R⁵⁴═H | | | | | | | Anmmonium |

Pro. Ex. No. = Product Example Number

A particularly preferred amine is hexamethylendiamine in polyamide, due to their structural similarities. Therefore, formula [11] or formula [II] reacted by hexamethylendiamine have good solubility and disperse in polyamide.

Examples of the black dyes containing a mixture of two dye salts of formula [I], or a mixture of the dye salt of formula [I] and the dye salt of formula [II] are below:

### EXAMPLE 1

### Black Dye

The anthraquinone dye salts of formula [1-21]: the anthraquinone dye salts of formula [1-23]: in a weight ratio of 4:5.

### EXAMPLE 2

### Black Dye

The anthraquinone dye salt of formula [1-7]: anthraquinone dye salt of formula [II-8]: in a weight ratio of 1:1.

Various perinone dyes can be mixed with the above-mentioned dye salt of formula [I] or formula [II] for use as a black colorant in the composition of the invention. These are known products of formula [III] below. Formula [III]:

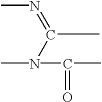

The perinone dyes which are mixed with the anthraquinone to produce a black dye may be used alone or in combination thereof.

Preferred perinone dyes used in the composition of the invention when solubility and/or dispersion in the resin are considered, are those of formula [IV], formula [IV]:

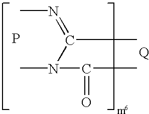

wherein P and Q, which may be the same or different, are independently constituent units represented by the following formulas [IV-a] to [IV-c]; and R¹⁴ to R²⁹, which may be the same or different, are independently an atom or a group selected from the group consisting of H, halogen atom such as Cl, Br, alkyl group having 1 to 18 carbon atoms, alkoxy group having 1 to 18 carbon atoms, aralkyl group, aryl group; and m⁶ is the number 1 or 2.

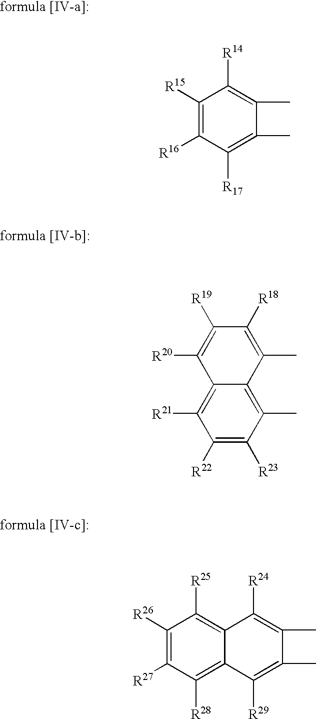

The above mentioned perinone dyes have practical heat resistance in molding and good transmittance in a main laser beam wavelength (800 nm to 1200 nm).

Dyes which belong to the class of perinone dyes listed in the color index are for example

C.I.Solvent Orange 60, 78, C.I.Solvent Red 135, 162, 178, 179, C.I.Solvent Violet 29, C.I.Pigment Orange 43, C.I.Pigment Red 149. If solubility and dispersibility in the resin are enhanced, solvent type dyes are preferred.

Examples of the perinone dyes of the formula [IV] are listed below in Table 3.

TABLE 3

| Pro. | | |
|---|---|---|
| Ex. | | |
| No. | P | Q |
| IV-1 | Formula[IV-b], | Formula[IV-a], |
| | R¹⁸═R¹⁹═R²⁰═R²¹═R²²═R²³═H | R¹⁴═R¹⁵═R¹⁶═R¹⁷═H |
| IV-2 | Formula[IV-b], | Formula[IV-a], |
| | R¹⁸═R¹⁹═R²⁰═R²¹═R²²═R²³═H | R¹⁴═R¹⁵═R¹⁶═R¹⁷═Cl |
| IV-3 | Formula[IV-b], | Formula[IV-c], |
| | R¹⁸═R¹⁹═R²⁰═R²¹═R²²═R²³═H | R²⁴═R²⁵═R²⁶═R²⁷═R²⁸═R²⁹═H |
| IV-4 | Formula[IV-a], | Formula[IV-b], |
| | R¹⁴═R¹⁵═R¹⁶═R¹⁷═H | R¹⁸═R¹⁹═R²⁰═R²¹═R²²═R²³═H |
| IV-5 | Formula[IV-b], | Formula[IV-c], |
| | R¹⁸═R¹⁹═R²⁰═R²¹═R²²═R²³═H | R²⁴═R²⁶═R²⁷═R²⁸═R²⁹═H, |
| | | R²⁵═OC₂H₅ |
| IV-6 | Formula[IV-b], | Formula[IV-a], |
| | R¹⁸═R¹⁹═R²⁰═R²¹═R²²═R²³═H | R¹⁴═R¹⁵═R¹⁷═H, R¹⁶═benzoyl |
| IV-7 | 2Formula[IV-b], | Formula[IV-a], |
| | R¹⁸═R¹⁹═R²⁰═R²²═R²³═H | R¹⁴═R¹⁷H |
| | R²¹═C₄H₉ | |
| IV-8 | Formula[IV-b], | Formula[IV-c], |
| | R¹⁸═R¹⁹═R²⁰═R²¹═R²²═R²³═H | R²⁴═R²⁶═R²⁷═R²⁸═R²⁹═H, |
| | | R²⁵═phenyl |
| IV-9 | Formula[IV-b], | Formula[IV-a], |
| | R¹⁸═R¹⁹═R²⁰═R²¹═R²²═R²³═H | R¹⁵═R¹⁶═R¹⁷═H, R¹⁴═Br |
| IV-10 | Formula[IV-b], | Formula[IV-a], |
| | R¹⁸═R¹⁹═R²⁰═R²¹═R²²═R²³═H | R¹⁵═R¹⁶═R¹⁷═H, R¹⁴═COOH |

Pro. Ex. No. = Product Example Number

Examples of the black dyes containing a mixture of the dye salts of formula [I] or formula [II] and perinone dyes are described below:

### EXAMPLE 3

### Black Dye

The anthraquinone dye salt of formula [I-11 ]: the anthraquinone dye salt of formula [I-3]: perinone red dye of the following formula [IV-3]: anthraquinone yellow dye of the following formula [a]in a weight ratio of 5:4:1:1.

Formula [a]

### EXAMPLE 4

### Black Dye

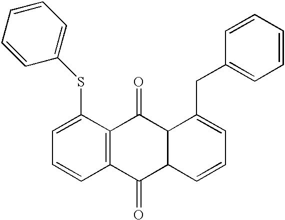

The anthraquinone dye salt of formula [I-11]: the anthraquinone dye salt of formula [I-7]: perinone orange dye of the following formula [IV-1]: anthraquinone yellow dye of the following formula [a]in a weight ratio of 5:3:1:1.

### EXAMPLE 5

### Black Dye

The anthraquinone dye salt of formula [I-21]: perinone red dye of the following formula [IV-3]: anthraquinone yellow dye of the following formula [a]in a weight ratio of 6:2:1.

### EXAMPLE 6

### Black Dye

The anthraquinone dye salt of formula [I-5]: perinone red dye of the following formula [IV-3]: perinone orange dye of the following formula [IV-1] in a weight ratio of 3:2:1.

### EXAMPLE 7

### Black Dye

The anthraquinone dye salt of formula [I-6]: perinone red dye of the following formula [IV-3]: anthraquinone yellow dye of the following formula [a] in a weight ratio of 6:2:1.

### EXAMPLE 8

### Black Dye

The anthraquinone dye salt of formula [I-6]: perinone red dye of the following formula [IV-3]: perinone orange dye of the following formula [IV-1] in a weight ratio of 3:2:1.

### EXAMPLE 9

### Black Dye The anthraquinone dye salt of formula [I-21]: perinone red dye of the following formula [IV-3]: anthraquinone yellow dye of the following formula [b] in a weight ratio of 3:2:1.

Formula [b]:

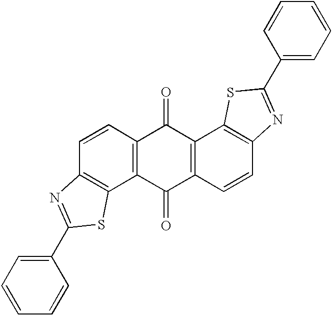

### EXAMPLE 10

### Black Dye

The anthraquinone dye salt of formula [I-23]: perinone red dye of the following formula [IV-3] in a weight ratio of 2:1.

### EXAMPLE 11

### Black Dye

The anthraquinone dye salt of formula [I-21]: the anthraquinone dye salt of formula [I-23]: perinone red dye of the following formula [IV-3] in a weight ratio of 3:1:1.

### EXAMPLE 12

### Black Dye

The anthraquinone dye salt of formula [I-9]: perinone red dye of the following formula [IV-2]: anthraquinone yellow dye of the following formula [b] in a weight ratio of 6:2:1.

### EXAMPLE 13

### Black Dye

The anthraquinone dye salt of formula [II-8]: perinone red dye of the following formula [IV-3]: anthraquinone yellow dye of the following formula [a]in a weight ratio of 6:2:1.

### EXAMPLE 14

### Black Dye

The anthraquinone dye salt of formula [II-4]: perinone red dye of the following formula [IV-2]: anthraquinone yellow dye of the following formula [a]in a weight ratio of 6:2:1.

### EXAMPLE 15

### Black Dye

The anthraquinone dye salt of formula [II-10]: perinone red dye of the following formula [IV-3]: anthraquinone yellow dye of the following formula [a]in a weight ratio of 6:2:1.

### EXAMPLE 16

### Black Dye

The anthraquinone dye salt of formula [II-2]: perinone red dye of the following formula [IV-3]: anthraquinone yellow dye of the following formula [b] in a weight ratio of 6:2:1.

### EXAMPLE 17

### Black Dye

The anthraquinone dye salt of formula [I-5]: The anthraquinone dye salt of formula [II-8]: perinone red dye of the following formula [IV-3] in a weight ratio of 3:3:1.

Dyes which belong to monoazo complex dyes can be mixed with the dye salts of formula [I] or formula [II] to produce a black dye for use as a colorant in the composition of the invention, and as represented by formula [V] below,

formula [V]

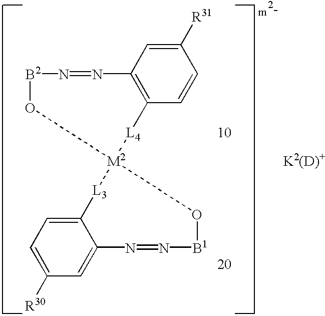

wherein R³⁰ and R³¹ which may be the same of different, are C1, SO₂R³², SO₂(—R³³)(—R³⁴) or H; wherein R³³ and R³⁴ which may be the same or different, are independently hydrogen atom, linear or branched C1-C4 alkyl; R³² is linear or branched C1-C4 alkyl; L₃ and L₄ are independently O or COO; (D)⁺ is hydrogen ion, cation of alkali metals, ammonium ion, cations of organic amine including aliphatic primary, secondary and tertiary amines, quaternary ammonium ion; K² is an integer, m² is 0, 1 or 2; M² is selected from metals of ionic valency from 2 to 4 (such as Zn, Sr, Cr, Al, Ti, Fe, Zr; Ni, Mn, B [boron] and Co), preferably a trivalent metal such as Cu or trivalent metals such as Cr. Co. Ni, and Al. B¹ and B ²are represented by formula [V-a] or formula [V-b].

formula [V-a]:

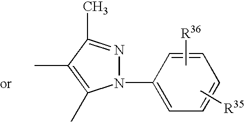

formula [V-b]:

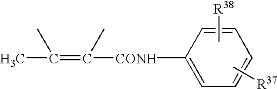

wherein R³⁵ and R³⁷, which may be the same of different, are C1, SO₂R³², SO₂(—R³³)(—R³⁴), or H; R³³ and R³⁴, which may be the same or different, are independently hydrogen atom, linear or branched C1-C4 alkyl; and R³⁶ and R³⁸, which may be the same or different, are independently hydrogen atom, linear or branched C1-C18 alkyl, carboxyl, hydroxyl, C1-C18 alkoxy, amino or halogen atoms.

Suitable cations for use in the above-mentioned monoazo complex dyes are H⁺; cations of alkali metal, ammonium ion, cations of organic amine (including aliphatic primary, secondary and tertiary amines), and quaternary ammonium ion.

Suitable amines for use in producing the above-mentioned monoazo dyes and common in dyestuffs include aliphatic amine, alicyclic amine, alkoxyalkyl amine, amine having alkanol, diamine, amine of guanidine derivatives, and aromatic amine.

Examples of the monoazo complex dyes of formula [V], wherein B¹ and B² are of the formula [V-a] are show below at Formula [V-c] and together with the accompanying information in Table 4.

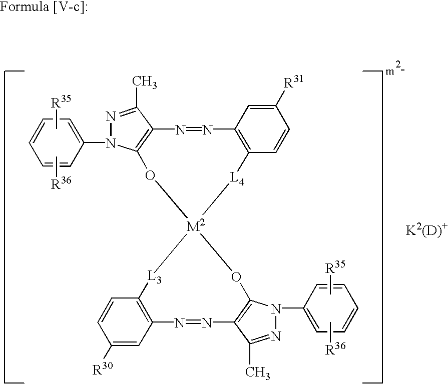

TABLE 4

| Pro. | | | | | | | | | |
|---|---|---|---|---|---|---|---|---|---|
| Ex. | | | | | | | | | |
| No | R³⁰ | R³¹ | R³⁵ | R³⁶ | M² | L₃ | L₄ | m² | K²(D)⁺ |
| V-1 | H | H | H | H | Cr | COO | COO | 1 | H⁺ |
| V-2 | Cl | Cl | SO₂NH₂ | H | Cr | O | O | 1 | H⁺ |
| V-3 | SO₂NH₂ | SO₂NH₂ | SO₂NH₂ | H | Cr | O | O | 1 | H⁺ |
| V-4 | Cl | Cl | SO₂NH₂ | H | Co | O | O | 1 | H⁺ |
| V-5 | SO₂NH₂ | SO₂NH₂ | H | H | Ni | O | O | 1 | H⁺ |
| V-6 | H | H | SO₂NH₂ | H | Cu | COO | COO | 1 | H⁺ |
| V-7 | H | H | H | H | Cr | COO | COO | 1 | C₄H₉CH(C₂H₅)OC₃H₆N⁺H₃ |
| V-8 | Cl | Cl | SO₂NH₂ | H | Cu | O | O | 1 | C₁₂H₂₅N⁺H₂(CH₂CH₂O)₂H |
| V-9 | Cl | Cl | SO₂NH₂ | H | Cr | O | O | 1 | Na⁺ |
| V-10 | Cl | SO₂NH₂ | H | Cl | Co | O | O | 1 | H⁺ |

Pro. Ex. No. = Product Example Number

Examples of the monoazo complex dyes of formula [V], wherein B¹ and B² are of the formula [V-b] are shown below at Formula [V-d] and together with the accompanying information in Table 5.

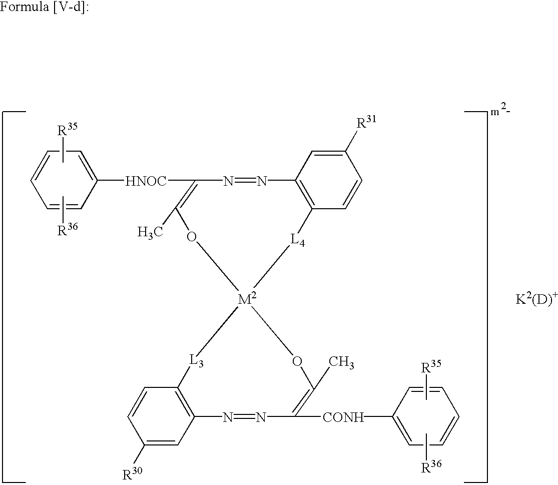

TABLE 5

| Pro. | | | | | | | | | |
|---|---|---|---|---|---|---|---|---|---|
| Ex. | | | | | | | | | |
| No. | R³⁰ | R³¹ | R³⁵ | R³⁶ | M² | L₃ | L₄ | m² | K²(D)⁺ |
| V-11 | SO₂NH₂ | SO₂NH₂ | H | H | Co | O | O | 1 | H⁺ |
| V-12 | H | H | SO₂NH₂ | H | Cr | COO | COO | 1 | H⁺ |
| V-13 | Cl | Cl | H | H | Co | O | O | 1 | C₄H₉CH(C₂H₅)OC₃H₆N⁺H |
| V-14 | SO₂NH₂ | SO₂NH₂ | SO₂NH₂ | H | Cr | O | O | 1 | NH₄⁺ |
| V-15 | Cl | Cl | SO₂NH₂ | H | Co | COO | COO | 1 | H⁺ |

Pro. Ex. No. = Product Example Number

Examples of the black dyes containing a mixture of the dye salts of formula [I] or formula [II] and at least one of the monoazo complex dyes of the following formula [V] are provided in detail below:

### EXAMPLE 18

### Black Dye

The anthraquinone dye salt of formula [II-2]: monoazo complex red dye of the following formula [V-2]: monoazo complex yellow dye of the following formula [V-14] in a weight ratio of 6:2:1.

### EXAMPLE 19

### Black Dye

The anthraquinone dye salt of formula [I-21]: monoazo complex red dye of the following formula [V-2]: monoazo complex orange dye of the following formula [V-3] in a weight ratio of 6:2:1.

### EXAMPLE 20

### Black Dye

The anthraquinone dye salt of formula [I-26]: monoazo complex red dye of the following formula [V-2]: monoazo complex orange dye of the following formula [V-3] in a weight ratio of 6:2:1.

### EXAMPLE 21

### Black Dye

The anthraquinone dye salt of formula [I-7]: monoazo complex red dye of the following formula [V-2]: anthraquinone yellow dye of the following formula [a]in a weight ratio of 6:2:1.

### EXAMPLE 22

### Black Dye

The anthraquinone dye salt of formula [I-5]: monoazo complex red dye of the following formula [V-2]: anthraquinone yellow dye of the following formula [b] in a weight ratio of 6:3:1.

Dyes which belong to anthrapyridone dyes can be mixed with the dye salts of formula [I] or formula [II] to produce a black dye for use as colorant in the composition of the invention, and are represented by formula[VI], Fomula [VI]:

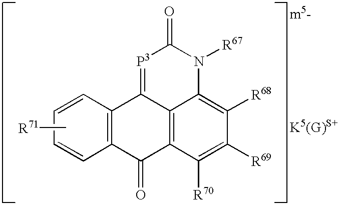

wherein R⁶⁷ to R⁷¹, which may be the same or different, are independently selected from the group consisting of H, alkyl, aryl, alkenyl, alkoxy, amino, hydroxy, halogen atom, acyl, acyloxy, acylamide, acyl-N-alkylamide, carboxyl, alkoxycarbonyl, cyclohexylamide, sulfonyl, or formula [VI-a], and at least one of R⁶⁷ to R⁷⁴ is of sulfonyl, wherein P³ may be the same or different, are independently selected from the group consisting of C—R⁷², N; R⁷² is H, alkyl, aryl, hydroxy, carboxyl, alkoxy, amino, benzoyl, benzyl wherein (G)ₛ₊ represents ammonium ion or a cation derived from an organic amine compounds or a basic dye wherein s is 1 or 2, m⁵ is an integer from 1 to 4 and K⁵ is the ratio of m⁵/s; formula [VI-a]:

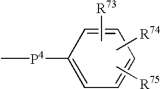

wherein P⁴ is O or NH, and R⁷³ to R⁷⁵, which may be the same or different, are independently selected from the group consisting of H, alkyl, aryl, alkenyl, alkoxy, amino, N-alkylamide, N-arylamide, hydroxy, halogen atom, acyl, acyloxy, acylamide, acyl-N-alkylamide, carboxyl, alkoxycarbonyl, or sulfonyl.

Suitable amines for use in producing the above-mentioned anthrapyridone dyes in dyestuffs include aliphatic amine, alicyclic amine, alkoxyalkyl amine, amine having alkanol, diamine, amine of guanidine derivatives, and aromatic amine.

These anthrapyridone dyes are considered having good solubility and/or dispersion in the resin.

Examples of the anthrapyridone dyes of formula [VI] appear in Table 6 below.

TABLE 6

| Pro. | | | |
|---|---|---|---|
| Ex. | | | |
| No. | R⁶⁷,R⁶⁸,R⁶⁹,R⁷⁰,R⁷¹ | P³ | K⁵(G)^{Σ+} |
| VI-1 | R⁶⁸═R⁶⁹═R⁷¹═H,R⁶⁷═CH₃,R⁷⁰═VI-a, | CH | H₃N⁺(CH₂)₆NH₂ |
| | Formula VI-a:P⁴═NH,R⁷³═SO₃⁻,R⁷⁴═R⁷⁵═H | | |
| VI-2 | R⁶⁸═R⁶⁹═R⁷¹═H,R⁶⁷═CH₃,R⁷⁰═VI-a, | CH | (CH₃)₃N⁺C₁₂H₂₅ |
| | Formula VI-a:P⁴═NH,R⁷³═SO₃⁻,R⁷⁴═R⁷⁵═H | | |
| VI-3 | R⁶⁸═R⁶⁹═R⁷¹═H,R⁶⁷═CH₃,R⁷⁰═VI-a, | CH | C₂H₅OC₃H₆N⁺H₃ |
| | Formula VI-a:P⁴═NH,R⁷³═SO₃⁻,R⁷⁴═R⁷⁵═H | | |
| VI-4 | R⁶⁸═R⁶⁹═R⁷¹═H,R⁶⁷═CH₃,R⁷⁰═VI-a, | CH | C₄H₉N⁺H₃ |
| | Formula VI-a:P⁴═NH,R⁷³═SO₃⁻,R⁷⁴═CH₃,R⁷⁵═H | | |
| VI-5 | R⁶⁸═R⁶⁹═R⁷¹═H,R⁶⁷═CH₃,R⁷⁰═VI-a, | CH | N-trimethyl-N-benzyl |
| | Formula VI-a:P⁴═NH,R⁷³═SO₃⁻,R⁷⁴═CH₃,R⁷⁵═H | | Anmmonium |
| VI-6 | R⁶⁸═R⁶⁹═R⁷¹═H,R⁶⁷═CH₃,R⁷⁰═VI-a, | CH | 2(CH₃)₄N⁺ |
| | Formula VI-a:P⁴═NH,R⁷³═R⁷⁴═SO₃⁻,R⁷⁵═H | | |
| VI-7 | R⁶⁸═R⁶⁹═R⁷¹═H,R⁶⁷═CH₃,R⁷⁰═VI-a, | CH | C₁₂H₂₅N⁺H₂(CH₂CH₂O)₂H |
| | Formula VI-a:P⁴═NH,R⁷³═SO₃⁻,R⁷⁴═C₄H₉,R⁷⁵═H | | |
| VI-8 | R⁶⁸═R⁶⁹═R⁷¹═H,R⁶⁷═CH₃,R⁷⁰═VI-a, | CH | N-trimethyl-N-benzyl |
| | Formula VI-a:P⁴═NH,R⁷³═SO₃⁻,R⁷⁴═Cl,R⁷⁴═H | | Anmmonium |
| VI-9 | R⁶⁸═R⁶⁹═R⁷¹═H,R⁶⁷═CH₃,R⁷⁰═VI-a, | N | C₂H₅OC₃H₆N⁺H₃ |
| | Formula VI-a:P⁴═NH,R⁷³═SO₃⁻,R⁷⁴═CH₃,R⁷⁵═H | | |
| VI-10 | R⁶⁸═R⁶⁹═R⁷¹═H,R⁶⁷═CH₃,R⁷⁰═VI-a, | N | C₁₂H₂₅N⁺H₃ |
| | Formula vi-a:P⁴═NH,R⁷³═SO₃⁻,R⁷⁴═C₈H₁₇,R⁷⁵═H | | |
| VI-11 | R⁶⁸═R⁶⁹═R⁷¹═H,R⁶⁷═H,R⁷⁰═VI-a, | C-C₄H₉ | Bis(p-methylphenyl) |
| | Formula VI-a:P⁴═NH,R⁷³═SO₃⁻,R⁷⁴═R⁷⁵═CH₃ | | guanidine anmmonium |
| VI-12 | R⁶⁷═R⁶⁹═R⁷¹═H,R⁶⁸═VI-a-1,R⁷⁰═VI-a-2, | C-benzoyl | (CH₃)₃N⁺C₁₂H₂₅ |
| | formula VI-a-1:P⁴═O,R⁷³═SO₃⁻,R⁷⁴═C₁₃H₂₇,R⁷⁵═H | | |
| | formula VI-a-2:P⁴═NH,R⁷³═SO₃⁻,R⁷⁴═R⁷⁵═CH₃ | | |
| VI-13 | R⁶⁷═R⁶⁹═R⁷¹═H,R⁶⁸═VI-a-1,R⁷⁰═VI-a-2, | C-benzoyl | N-trimethyl-N-benzyl |
| | Formula VI-a-1:P⁴═O,R⁷³═SO₃⁻,R⁷⁴═CH₃,R⁷⁵═H | | anmmonium |
| | formula VI-a-2:P⁴═NH,R⁷³═SO₃⁻,R⁷⁴═R⁷⁵═CH₃ | | |
| VI-14 | R⁶⁸═R⁶⁹═R⁷¹═H,R⁶⁷═CH₃,R⁷⁰═VI-a, | C-benzoyl | (C₄H₉)₄N⁺ |
| | Formula VI-a:P⁴═O,R⁷³═SO₃⁻,R⁷⁴═R⁷⁵═H | | |
| VI-15 | R⁶⁸═R⁶⁹═R⁷¹═H,R⁶⁷═CH₃,R⁷⁰═VI-a, | CH | N-trimethyl-N-benzyl |
| | Formula VI-a:P⁴═NH,R⁷³═SO₃⁻,R⁷⁴═R⁷⁵═H | | anmmonium |
| VI-16 | R⁶⁸═R⁶⁹═R⁷¹═H,R⁶⁷═CH₃,R⁷⁰═VI-a, | CH | H₃N⁺(CH₂)₆NH₂ |
| | Formula VI-a:P⁴═NH,R⁷³═SO₃⁻,R⁷⁴═CH₃,R⁷⁵═H | | |
| VI-17 | R⁶⁸═R⁶⁹═R⁷¹═H,R⁶⁷═CH₃,R⁷⁰═VI-a, | N | Diphenylguanidine |
| | Formula vi-a:P⁴═NH,R⁷³═SO₃⁻,R⁷⁴═C₈H₁₇,R⁷⁵═H | | anmmonium |

Pro. Ex. No. = Product Example Number

Examples of the black dyes containing a mixture of the dye salts of formula [I] or formula [II] and at least one of the anthrapyridone dye of the following formula[VI] are described below:

### EXAMPLE 23

### Black Dye

The anthraquinone dye salt of formula [I-5]: anthrapyridone red dye of the following formula [VI-2]: monoazo complex yellow dye of the following formula [V-14] in a weight ratio of 6:2:1.

### EXAMPLE 24

### Black Dye

The anthraquinone dye salt of formula [I-6]: anthrapyridone red dye of the following formula [VI-1] in a weight ratio of 2:1.

### EXAMPLE 25

### Black Dye

The anthraquinone dye salt of formula [I-7]: anthrapyridone red dye of the following formula [VI-18] in a weight ratio of 2:1.

### EXAMPLE 26

### Black Dye

The anthraquinone dye salt of formula [I-5]: anthrapyridone red dye of the following formula [VI-9]: anthraquinone yellow dye of the following formula [b] in a weight ratio of 6:2:1.

### EXAMPLE 27

### Black Dye

The anthraquinone dye salt of formula [I-5]: anthrapyridone red dye of the following formula [VI-9] in a weight ratio of 3:1.

### EXAMPLE 28

### Black Dye

The anthraquinone dye salt of formula [I-4]: the anthraquinone dye salt of formula [I—II]: anthrapyridone red dye of the following formula [VI-2] in a weight ratio of 5:5:1.

### EXAMPLE 29

### Black Dye

The anthraquinone dye salt of formula [1-29]: anthrapyridone red dye of the following formula [VI-15] in a weight ratio of 4:1.

### EXAMPLE 30

### Black Dye

The anthraquinone dye salt of formula [I-3]: anthrapyridone red dye of the following formula [VI-4]: anthraquinone yellow dye of the following formula [a]in a weight ratio of 5:2:1.

Beside ever mentioned examples of the black dyes, by following mixture there can produce a black dye.

### EXAMPLE 31

### Black Dye

The anthraquinone dye salt of formula [I-2]: anthraquinone yellow dye of the following formula [a]in a weight ratio of 6:1.

The thermoplastic resins for use in the inventive compositions include polyamides, polyesters, and the like as are commonly used in making a molded product. As the examples of the polyamide resins utilized in the present invention, condensation products of dicarboxylic acids and diamines, condensation products of aminocarboxylic acids and ring-opening polymerization products of cyclic lactams can be cited. As examples of dicarboxylic acids, adipic acid, azelaic acid, sebacic acid, dodecanedioic acid, isophthalic acid and terephthalic acid can be cited. As examples of diamines, tetramethylene diamine, hexamethylene diamine, octamethylene diamine, nonamethylene diamine, dodecamethylene diamine, 2-methylpentamethylene diamine, 2-methyloctamethylene diamine, trimethylhexamethylene diamine, bis(p-aminocyclohexyl)methane, m-xylene diamine and p-xylene diamine may be cited. As the example of aminocarboxylic acid, 11-aminododecanoic acid can be cited. As the examples of cyclic lactam, caprolactam and laurolactam can be cited. As the specific examples of condensation products and ring-opening polymerization products, aliphatic polyamides such as nylon 6, nylon 66, nylon 46, nylon 610, nylon 612, nylon 11, nylon 12, semi-aromatic polyamides such as polymetaxylene adipamide (nylon MXD6), polyhexamethylene terephthalamide (nylon 6T), polyhexamethylene isophthalamide (nylon 6I) and polynonamethylene terephthalamide nylon 9T), and copolymers and mixtures of these polymers can be cited. As the examples of the copolymers, nylon 6/66, nylon 66/6I, nylon 6I/6T and nylon 66/6T can be cited.

A wide range of common polyester molding compositions useful for blending with colorants in the practice of the present invention are known in the art. These include polymers which are, in general, condensation products of dicarboxylic acids and diols. Dicarboxylic acids can be selected from the group consisting of adipic acid, azelaic acid, sebacic acid, dodecanedioic acid, terephthalic acid, isophthalic acid, naphthalenedicarboxylic acid and diphenyl dicarboxylic acid, and diols can be selected from the group consisting of ethylene glycol, propylene glycol, butanediol, hexanediol, neopentyl glycol, cyclohexanediol, and bisphenol A. Preferred polyesters include polyethylene terephtalate (PET), polypropylene terephthalate (3GT), polybutylene terephthalate (PBT), polyethylene 2,6-naphthalate (PEN), polycyclohexane dimethylene terephthalate (PCT) and copolymers and mixtures thereof. As the examples of the copolymers, some of dicarboxylic acids or some of diols can be added to the condensation products. Polyester polymers may be copolymerized a little amount of compnents like trimesic acid, trimellitic acid, pyromellitic acid, glycerol, and pentaerythritol which have more than 3 functional groups.

Additional other polymers such as polycarbonate can also be presented, provided that the essential characteristics of the composition of the present invention are not substantially altered.

The amine salt of anthraquinone dyes of formula [I] or formula [II] are present in an amount of from 0.01 to 1% by weight, when the composition comprises polyamide 6 as at least the major component of the polyamide resin composition. The amount of the amine salt of anthraquinone dyes of formula [I] or formula[II] may be specialized for applications requiring different properties associated with the laser welding.

The composition of the present invention may contain an inorganic filler or reinforcing agent that includes, for example, fibrous reinforcement such as glass fiber and carbon fiber, glass flakes, glass beads, talc, kaolin, wollastonite, silica, calcium carbonate, potassium titanate and mica. Glass fiber and flakes are preferred selections. Glass fibers suitable for use in the present invention are those generally used as a reinforcing agents for thermoplastic resins and thermosetting resins. The preferred amount of glass fiber in the resin composition of the present invention is from about 5 to about 120 parts by weight, with respect to 100 parts by weight of the thermoplastic resin. If it is under 5 weight percent, it would be difficult to give sufficient reinforcement from the glass fiber, and if it is over 120 weight percent, it would have poor processibility and poor transparency to laser. It is preferable at about 5 to about 100 weight percent, and particularly preferable at about 15 to about 85 weight percent.

One or more optional compounds selected from a wide variety of compounds tailored for different applications of the resin compositions can be included in the compositions according to the present invention, as is understood among those having skill in the art.

Typically, additive compounds can include flame retardants, impact modifiers, viscosity modifiers, heat resistance improvers, lubricants, antioxidants and UV-and other stabilizers. The polyamide resin compositions of the present invention may have such additive compounds in suitable amounts so as not to harm characteristic properties of the compositions.

In the present invention, thermoplastic resin compositions are provided that are suitable for laser welding, including transparent articles for laser beam transmission to achieve welding together with the opaque article for laser beam absorption. Suitable opaque articles and their compositions are described for example in DE-A-4432081.

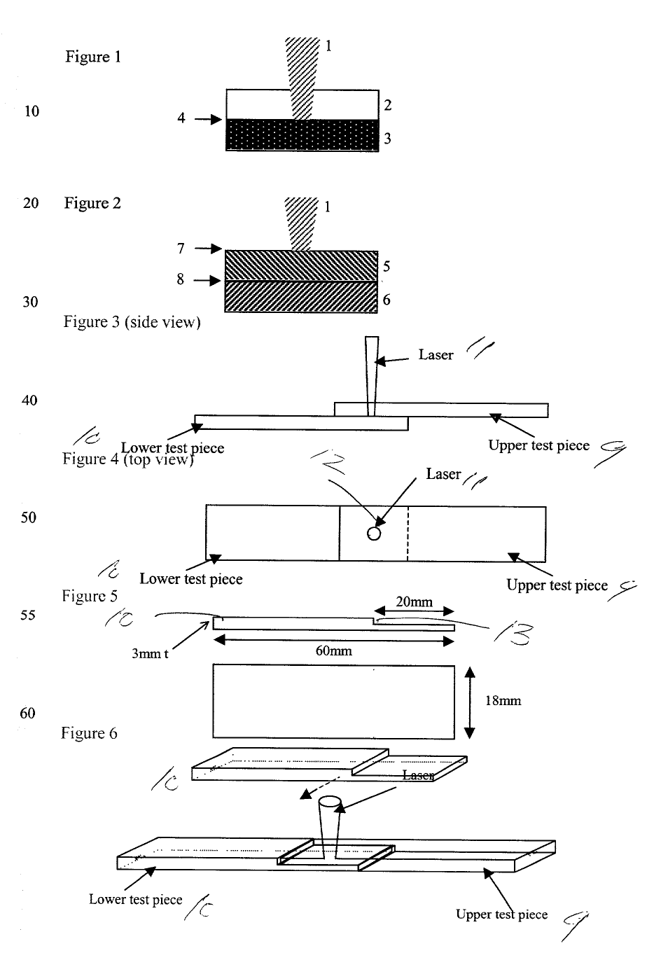

FIG. 1 is an illustration of a conventional laser welding arrangement. A laser beam 1 is transmitted through the first article 2 to the second article 3 containing laser beam absorbing combination, and the surface 4 of the second article 3 that have absorbed the laser energy 1 is melted and pressed with the surface of the first article 2 to weld them together. As shown in FIG. 2, first article 5 and second article 6 join at surface 8. The laser beam 1 is applied to the surface 7 of first article 5. Two thermoplastic components must have different transmission and absorption coefficients and it is difficult to weld two articles having the same color.

### EXAMPLES

The present invention is illustrated by the following examples and comparative examples, but it should be construed that the invention is in no way limited to those examples. These examples are in part directed to the practical laser weldability of a combination of laser transmitting articles formed from the compositions of the Examples with laser absorbing articles formed by other compositions. Illustrations include nylon 6 (see Table 10 and 13), 66 (see Table 14) and polyester (see Table 15). Other properties necessary for use in molding articles being subject to laser welding, including laser transmission capability, are shown in other tables.

For instance, Examples A, B, C, J, K, M and Comparative Examples D, E, F. L, N are directed to the transmittance of the article.

### Example A

400 grams of Nylon 6 ZYTEL pellets (available from E.I. DuPont de Nemours and Co., under the products name ZYTEL® 7301) were dried under vacuum at 120° C., for more than 8 hours, then mixed with a mixture of amine salt of anthraquinone dye, of formula [1-21] (0.53 g) with perinone red dye represented by the formula [IV-3] (0.18 g) and anthraquinone yellow dye represented by the formula [a](0.09 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 250° C. Mold temperature was 60° C. Good and uniformly black appearance and surface gloss without color shading of the specimens were observed.

### Example B

400 grams of Nylon 6 ZYTEL pellets (available from E.I. DuPont de Nemours and Co., under the product name ZYTELS 7301) were dried under vacuum at 120° C., for more than 8 hours, then mixed with a mixture of amine salt of anthraquinone dye of fomula [1-21] (0.53 g) with monoazo complex red dye of the following formula [V-2] (0.18 g) and another monoazo complex orange dye of the following formula [V-3] (0.09 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 250° C. Mold temperature was 60° C. Good and uniformly black appearance and surface gloss without color shading of the specimens were observed.

### Example C

400 grams of Nylon 6 ZYTEL pellets (available from E.I. DuPont de Nemours and Co., under the product name ZYTEL® 7301) were dried under vacuum al 120° C., for more than 8 hours, then mixed with a mixture of amine salt of anthraquinone dye of formula [1-6] (0.53 g) with perinone red dye represented by the formula [IV-3] (0.18 g) and anthraquinone yellow dye represented by the formula [a](0.09 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 250° C. Mold temperature was 60° C. Good and uniformly black appearance and surface gloss without color shading of the specimens were observed.

Comparative Example D

400 grams of Nylon 6 ZYTEL pellets (available from E.I. DuPont de Nemours and Co., under the product name ZYTEL® 7301) were dried under vacuum at 120° C., for more than 8 hours, then mixed with a mixture of anthraquinone green dye of the following formula [c] (0.53 g) with perinone red dye represented by the formula [IV-3] (0.18 g) and anthraquinone yellow dye represented by the formula [a](0.09 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 250° C. Mold temperature was 60° C. Good and uniformly black appearance and surface gloss without color shading of the specimens were cbserved.

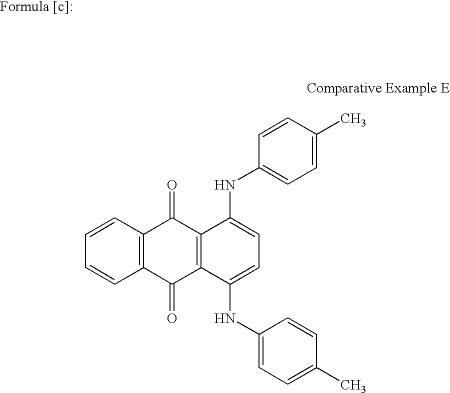

400 grams of Nylon 6 ZYTEL pellets (available from E.I. DuPont de Nemours and Co., under the product name ZYTEL® 7301) were dried under vacuum at 120° C., for more than 8 hours, then mixed with a mixture of anthraquinone violet dye of the following formula [d] (0.53 g) with perinone red dye represented by the formula [IV-3] (0.18 g) and anthraquinone yellow dye represented by the formula [a](0.09 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 250° C. Mold temperature was 60° C. Good and uniformly black appearance and surface gloss without color shading of the specimens were observed.

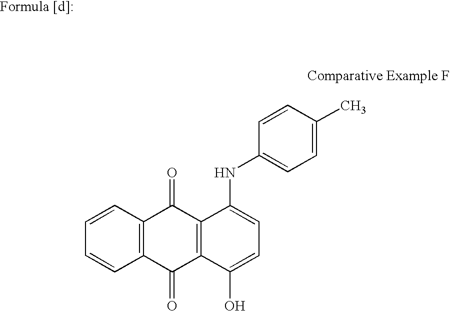

400 grams of Nylon 6 ZYTEL pellets (available from E.I. DuPont de Nemours and Co., under the product name ZYTEL® 7301) were dried under vacuum at 120° C., for more than 8 hours, then mixed with the monoazo complex black dye of the following formula [e] (0.80 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 250° C. Mold temperature was 60° C. Good and uniformly black appearance and surface gloss without color shading of the specimens were observed.

formula [e]:

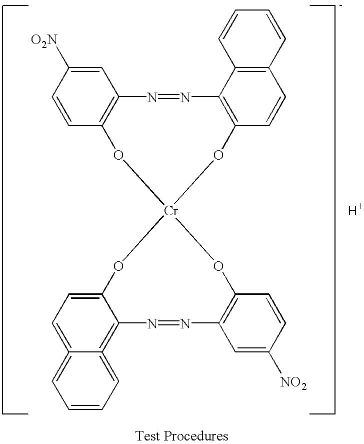

(1) Transmission Properties

Transmittance (T) in the range of 400 nm to 1200 nm of the test plates with laser beams having respective wavelengths of 940 nm(Semiconductor laser) and 1064 nm (YAG laser) was measured using a U-3410 spectrometer producted by Hitachi with 60+sphere photometer for wavelength from ultraviolet to near-infrared. The ratio (TA) of transmission with 940 nm : transmission with 1064 nm and the ratio (TB) of transmission with 940 nm : tarnsmission of natural resin are determined and compared between the examples.

(2) Appearance and Surface Gloss

Appearance of the test plates were evaluated by measuring Reflection Density (OD) of the test plates by Refelection Density meter TR-927 produced by Macbeth. Test plates having higher OD values are judged to have better surface smoothness and rich in gloss.

(3) Light Resistance

Each test plate was exposed to Xenon Weather Meter(produced by Toyo Seiki K. K., trade name: AtlasCI-4000) for 150 hours according to the following conditions. The amount of color fading and discoloration E between “before” and “after” light irradiation was determined and measured using a colorimeter (produced by Juki, trade name. JP 7000).

Conditions of Light Resistance Test Procedure

| | |
|---|---|
| Radial illumination (W/m²)(E) | 60 |
| Black standard temperature (° C.) | 83 |
| Rain test | N |
| Chamber temparture (° C.) | 55 |
| Moisture (%) | 50 |

The test plate having greater A E are judged to have greater discoloring and fading.

(4) Thermal Resistance

The amount of color fading and discoloration AE between “before” and “after” each test plate being placed and kept in an oven at 160° C. for 15 days was determined and measured using a colorimeter (produced by Juki, trade name: JP 7000).

(5) Moisture Resistance

The amount of color fading and discoloration AE between “before” and “after” each test plate being placed and kept in a thermoregulator at 80° C.(a humidity was 95%) for one week was determined and measured using a calorimeter (produced by Juki, trade name: JP 7000).

(6) TG(Thermogravimetric alalyzers)/ DTA (Differential thermal analyzers)

TG and DTA of each test colorant powder were measured using TG/DTA C was in the range of 200° C. to 300° C. and there is no adverse effect on thermoplastic resin due to addition of colorants during molding thereof.

(8) Blooming Resistance

The molded plates obtained as Example A and Comparative Example D were placed in an oven set at 60 deg. C with 95% relative humidity for 1 week. Then the plates were wiped with white cotton cloth and color change of the cotton appearance was visually examined. The results are shown in Table 8.

TABLE 8

| | | Comparative |
|---|---|---|
| | Example A | Example D |
| Cotton Appearance | No change | Colored to |
| | | deep green |

Example G

14 kg of Nylon 6 Zytel® pellets (available from E.I. DuPont de Nemours and Co., under the product name ZYTEL® 7301), 8.8 grams of CuI, 100 grams of aluminum distearate, and 6 kg of fiberglass (TP57, available from Nippon Sheet Glass Co., Ltd.) were mixed and extruded on the twin-screw extruder (ZSK-40 of W&P).

5 kg of the obtained pellets were dried in a dehumidified dryer set at 80° C. for more than 4 hours and mixed with 10grams of a dye mixture of the amine salt of anthraquinone dye of formula[I-21] (6.6grams), perinone red dye of the formula [I-3] used in Example A (2.3grams) and anthraquinone yellow dye of the formula [a]used in Example A (1.1 grams).

The dye-mixed pellets above were then molded into the test pieces according to the ISO₃₁₆₇ on Toshiba IS 170FIII molding machine, with cylinder temperature set at 260° C. and mold temperature at 80° C. , and the test pieces of 60 mm×18 mm×1.5 mm on Sumitomo 75T molding machine, with cylinder temperature set at 260° C. and mold temperature at 80° C.

(9) Tensile Properties and Heat Aging

Tensile strength and elongation were measured in Table 9 according to ISO₅₂₇ after molding and after heat aging at 150° C. for 1000 hours. Test piece appearance was also observed.

TABLE 9

| | | Example | Comparative | Comparative |
|---|---|---|---|---|
| | | G | Example H | Example I |
| After | Tensile Strength (MPa) | 183 | 171 | 190 |
| Molding | Elongation (%) | 3.6 | 3.4 | 3.8 |
| After Aging | Tensile Strength (MPa) | 191 | 181 | 155 |
| | Elongation (%) | 3.1 | 3.2 | 2.1 |
| | Appearance | Black | Dark brown | Black |

(10) Laser Welding Test

The 60 mm×18 mm×1.5 mm test pieces were placed so that 20 mm of each be overlapped. The overlapped area was irradiated with a diode laser (SDL—FD25, 820 nm continuous) set at 4W with 3 mm diameter for 10 seconds. (See FIG. 3&4). See FIGS. 3 and 4 depicting the arrangement of upper test piece 9 and lower test piece 10 for this test. The laser 11 is focused in the area 12 and the test pieces 9 and 10 are thereby joined together. FIGS. 3-6 illustrate preparation of laser welding test and how to carry out the laser welding tests.

TABLE 10

| Upper test piece | Example G | Comparative Example H |
|---|---|---|
| Lower test piece | Comparative Example I | Comparative Example I |
| Welding results | Good adhesion | Could not adhere |

A variation of the test described immediately above is shown in FIGS. 5 and 6. Each of the upper test piece 9 and lower test piece 10 have a notch 13 which is 20 mm in length. When the test pieces 9 and 10 are joined together, a smooth surface is thereby created, which is subjected to the laser 11 as described above.

Example G exhibited good adhesion in laser welding with an opaque workpiece part for a laser beam, being made of thermoplastic resin containing carbon black. The mechanical properties after molding and aging showed no deterioration and appearance of thermoplastic resin was not changed even when a colorant was added.

### Example J

400 grams of Nylon 66 ZYTEL 101 pellets (available from E.I. DuPont de Nemours and Co.) were dried under vacuum at 120° C., for more than 8 hours, then mixed with a mixture of amine salt of anthraquinone dye of formula [I-21] (0.53 g) with perinone red dye represented by the formula [IV-3] (0.18 g) and anthraquinone yellow dye represented by the formula [a](0.09 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 290° C. Mold temperature was 60° C. Good and uniformly black appearance and surface gloss without color shading of the specimens were observed.

### Example K

400 grams of Nylon 66 ZYTEL 101pellets (available from E.I. DuPont de Nemours and Co.) were dried under vacuum at 120° C., for more than 8 hours, then mixed with a mixture of amine salt of anthraquinone dye of the formula [II-8] (0.53 g) with perinone red dye represented by the formula [IV-3] (0.18 g) and anthraquinone yellow dye represented by the formula [a](0.09 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 290° C. Mold temperature was 60° C. Good and uniformly black appearance and surface gloss without color shading of the specimens were observed.

Comparative Example L

400 grams of Nylon 66 ZYTEL 101pellets (available from E.I. DuPont de Nemours and Co.) were dried under vacuum at 120° C., for more than 8 hours, then mixed with a mixture of anthraquinone violet dye of the following formula [d] (0.68 g) with quinophthalone yellow dye represented by the formula [f] (0.12 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 290° C. Mold temperature was 60° C. Good and uniformly black appearance and surface gloss without color shading of the specimens were observed.

formula [f]:

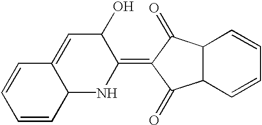

TABLE 11

| | | | | Comparative. |
|---|---|---|---|---|
| | | Example J | Example K | Example L |
| Transmission | TA | 0.94 | 0.94 | 0.93 |
| | TB | 0.95 | 0.96 | 0.91 |
| OD | | 2.40 | 2.41 | 2.32 |

| | | | |
|---|---|---|---|
| Thermal Resistance ΔE | 0.51 | 0.47 | 1.30 |
| Moisture Resistance ΔE | 0.14 | 0.36 | 1.02 |
| TG/DTA | | | |
| Exothermic peak (° C.)/ | 346.5,506.2/ | 346.9/ | 320.9/ |
| Endothermic peak (° C.) | none | none | 179.5 |

This testing demonstrates that Examples J and K showed high transmittance at a main wavelength in infra-red region (800 nm to 1200 nm) and good surface gloss. In thermal and moisture resistances, Examples J and K were much better than Comparative Example L containing a neutral anthraquinone.

### Example M

400 grams of glass reinforced polyester pellets (prepared from terephthalic acid and ethylene glycol the intrinsic viscosity of which is 0.85 when measured at 25° C. as a 1% solution in a mixed solution of phenol and dichlorobenzene with the weight ratio of 1/1 and containing 30wt % chopped strand glass fibers 187H produced by Nippon Electric Glass Co., Ltd. based on a total weight of the polyester resin composition) were dried under vacuum at 120° C., for more than 8 hours, then mixed with a mixture of amine salt of anthraquinone dye of formula [I-11] (0.50 g), amine salt of anthraquinone dye represented by the formula [I-14] (0.40 g) and amine salt of anthrapyridone dye represented by the formula [VI-2] (0.10 g) in a stainless tumble mixer with stirring for one hour. The mixture was then injection molded to form the injection molded test specimens (whose sizes are 48 mm×86 mm×3 mm) using K50-C produced by Kawaguchi Steel K.K. and the cylinder temperature was set to 290° C. Mold temperature was 60° C. Good and uniformly black appearance and surface gloss without color shading of the specimens were observed. See Table 12.

### Comparative Example N

400 grams of glass reinforced polyester pellets of Example M were dried under vacuum at 120° C., for more than 8 hours, then mixed with a mixture of anthraquinone violet dye of the following formula [d] (0.68 g) with quinophthalone yellow dye represented by the formula [f] (0.12 g) in a stainless tumble mixer with stirring for one hour. The mixture was then injection molded to form the injection molded test specimens (whose sizes are 48 mm×86nim×3 mm) using K50-C produced by Kawaguchi Steel K.K. and the cylinder temperature was set to 290° C. Mold temperature was 60° C. Good and uniformly black appearance and surface gloss without color shading of the specimens were observed. See Table 12

TABLE 12

| | | | Comparative. |
|---|---|---|---|
| | | Example M | Example N |
| Transmission | TA | 0.92 | 0.92 |
| | TB | 0.85 | 0.89 |
| OD | | 1.90 | 1.86 |

| | | |
|---|---|---|
| Moisture Resistance ΔE | 0.61 | 3.58 |
| TG/DTA | | |
| Exothermic peak (° C.)/ | 337.0/ | 320.9/ |
| Endothermic peak (° C.) | none | 179.5 |

This testing demonstrates that in moisture resistances Examples M were much better than Comparative Example N containing a neutral anthraquinone. If a colored resin composition as like Comparative Example N is used in rich humid atmosphere, it has high possibility to discolor.

### Example O-Example R, Comparative Example S-T

Fiberglass reinforced nylon 6 (Zytel®73G30L, available from E. I. DuPont de Nemours and Co.) and dyes were dry-blended with the amount described in table 13. The blended material was molded into two types of test pieces: one for mechanical properties, and another for laser welding. Test pieces for mechanical properties were molded according to the ISO₃₁₆₇ on the Toshiba IS 170FIII injection molding machine, with cylinder temperature set at 260° C. and mold temperature at 80° C. Test pieces for laser welding, with dimensions illustrated as in FIG. 5, were molded on the Sumitomo Juki 75T injection molding machine, with cylinder temperature set at 250° C. and mold temperature set at 80° C. Tensile strength and elongation were measured according to ISO₅₂₇ and notched Charpy impact strength was measured according to ISO179.

Laser welding was conducted using two pieces of the test pieces described above, FIG. 5, were molded on the Sumitomo Juki 75T injection molding machine, with cylinder temperature set at 270° C. and mold temperature set at 80° C.

Tensile strength and elongation were measured according to ISO₅₂₇ and notched Charpy impact strength was measured according to ISO179.

Laser welding was conducted using two pieces of the test pieces described above, combined as illumed in FIG. 6. Each Example from U to Z and Comparative Example AA was used as Upper test piece and Comparative Example AB was used as Lower test piece. Diode laser (wavelength 940 nm, manufactured by Rofin-Sinar Laser GmbH) was irradiated with various power and speed, with 3 mm diameter. Tensile strength of the welded test pieces were measured on Autograph (manufactured by Shimazu Seisakusho) by pulling apart at 5 mm/minute and its maximum load was recorded.

TABLE 14

| | Example | Example | Example | Example | Example | Example | Comp. | Comp. |
|---|---|---|---|---|---|---|---|---|
| | U | V | W | X | V | Z | Ex. AA | Ex. AB |
| 70G33HS1L kg | 4.9925 | 4.9925 | 4.9925 | 4.9925 | 4.9925 | 4.9925 | 5 | 4.99 |
| Amine salt of anthraquinone dye [I-21] | 5.00 g | 5.00 g | | | | | | |
| Amine salt of anthraquinone dye [I-23] | | | 5.00 g | | | | | |
| Amine salt of anthraquinone dye [I-13] | | | | 5.63 g | | | | |
| Amine salt of anthraquinone dye [II-8] | | | | | 5.00 g | | | |
| Amine salt of anthraquinone dye [II-7] | | | | | | 5.00 g | | |
| Monoazo complex red dye [V-2] | 1.67 g | | | | | | | |
| Monoazo complex orange dye [V-3] | 0.83 g | | | | | | | |
| Perinone red dye [IV-3] | | 1.67 g | 2.50 g | 1.88 g | 1.67 g | 1.67 g | | |
| Yellow dye [a] | | 0.83 g | | | 0.83 g | 0.83 g | | |
| Carbon black | | | | | | | | 10 g |
| Tensile strength MPa | 198 | 203 | 197 | 197 | 197 | 194 | 206 | 207 |
| Elongation % | 3.5 | 3.3 | 3.4 | 3.5 | 3.5 | 3.4 | 3.6 | 3.2 |
| Notched Charpy kJ/m² | 12.7 | 12.4 | 12.8 | 12.6 | 12.7 | 12.5 | 12.8 | 11.9 |
| Laser Welding at 80W | | | | | | | | |
| 2.5 m/min kgf | 82 | 57 | 96 | 86 | 204 | 177 | 95 | — |
| 5 m/min kgf | 180 | 193 | 184 | 181 | 192 | 196 | 184 | — |
| 10 m/min kgf | 182 | 113 | 185 | 167 | 89 | — | 172 | — |

### Example AC, Comparative Example AD-AE

Fiberglass reinforced polyester pellets of Example M and dyes were dry-blended black to the natural colored polyester.

1. A thermoplastic resin composition for laser welding comprising:
1) thermoplastic resin; and
2) laser-transmitting black colorant comprising amine salt of anthraquinone dye.

2. A thermoplastic resin composition for laser welding comprising:
1) thermoplastic resin; and,
2) laser-transmitting black colorant comprising amine salt of anthraquinone dyes of formula [I] or formula [II],
wherein Formula [I] is: 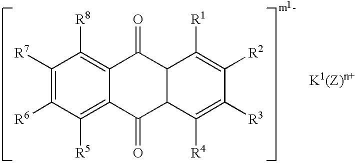
wherein R¹ to R⁸, which may be the same or different, are independently selected from the group consisting of H, alkyl, aryl, alkenyl, alkoxy, amino, hydroxy, halogen atom, acyl, acyloxy, acylamide, acyl-N-alkylamide, carboxyl, alkoxycarbonyl, cyclohexylamide, sulfonyl, formula [I-a], or -Y-W, and at least one of R¹ to R⁸ is of formula [I-a]; wherein Y is S, O, or NH; wherein W is selected from unsubstituted or substituted alkyl group, alkenyl group, and unsubstituted or substituted aryl group; wherein (Z)ⁿ⁺ represents ammonium ion or a cation derived from an organic amine compounds or a basic dye; wherein n is 1 or 2, m¹ is an integer from 1 to 4 and K¹ is the ratio of m¹/n;
and wherein formula [I-a] is: 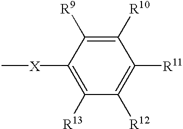
wherein X is O or NH, and R⁹ to R¹³, which may be the same or different, are independently selected from the group consisting of X, alkyl, aryl, alkenyl, alkoxy, amino, N-alkylamide, N-arylamide, hydroxy, halogen atom, acyl, acyloxy, acylamide, acyl-N-alkylamide, carboxyl, alkoxycarbonyl, or sulfonyl; wherein at least one of R¹ to R⁸ and R⁹ to R is sulfonyl group; and wherein formula [II] is: 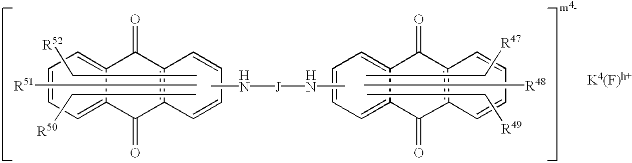
wherein R⁴⁷ to R⁵², which may be the same or different, are independently selected from the group consisting of H, alkyl, aryl, alkenyl, alkoxy, amino, N-alkylamide,N-arylamide, hydroxy, halogen atom, acyl, acyloxy, acylamide, acyl-N-alkylamide, carboxyl, alkoxycarbonyl, or sulfonyl; and at least one of R⁴⁷ to R⁵² is of sulfonyl; and
Formula J in formula [II] is selected from formula [II-a] or formula [II-b] and binds two anthraquinone,
Wherein formula [II-a] is: 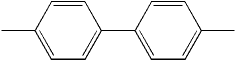
wherein R⁵³ to R⁵⁴, which may be the same or different, are independently selected from the group consisting of alkyl(having 1 to 8 carbon atoms) or hydrogen; and wherein (F)^{h+}represents ammonium ion or a cation derived from an organic amino compounds or a basic dye wherein h is 1 or 2, m⁴ is an integer from 1 to 4 and K⁴ is the ratio of m⁴/h.

3. The composition of claim 1 further comprising a second dye mixed with said amine salt of said anthraquinone dye to produce a laser-transmitting black dye.

4. The composition of claim 2 further comprising a second dye mixed with said amine salt of a said anthraquinone dye to produce a laser-transmitting black dye.

5. The composition of claim 4, wherein said second dye is selected from the group consisting of perinone dyes, monoazo complex dyes, anthrapyridone dyes and anthraquinone dyes.

6. The composition of claim 2 further comprising (i) a red dye to be mixed with said amine salt of said anthraquinone dye to produce a laser-transmitting black dye, said red dye selected from the group consisting of perinone dyes, monoazo complex dyes, and anthrapyridone dyes; and (ii) an additional yellow dye to be added to said mixture selected from the group consisting of monoazo complex dyes and anthraquinone dyes.

7. The composition of any one of claims 1-6 in which said thermoplastic resin is polyamide or polyester.

8. The composition of claim 7, further comprising reinforcing agent.

9. A laser-transparent article formed from the composition of any one of claims 1-6.

10. An article formed by laser welding an opaque article with the laser-transparent article of claim 9.

11. A laser-transmitting black colorant suitable for being mixed with a thermoplastic resin comprising at least amine salt of anthraquinone dyes.

12.A laser-transmitting black colorant suitable for being mixed with a thermoplastic resin comprising amine salt of anthraquinone dyes of formula [I] or formula [II], 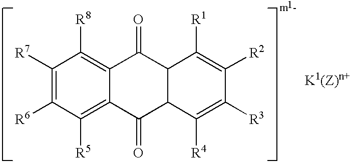
wherein R¹ to R⁸, which may be the same or different, are independently selected from the group consisting of H, alkyl, aryl, alkenyl, alkoxy, amino, hydroxy, halogen atom, acyl, acyloxy, acylamide, acyl-N-alkylamide, carboxyl, alkoxycarbonyl, cyclohexylamide, sulfonyl, formula [I-a], or -Y-W, and at least one of R¹ to R⁸ is of formula [I-a]; wherein Y is S, O, or NH; wherein W is selected from unsubstituted or substituted alkyl group, alkenyl group, and unsubstituted or substituted aryl group; wherein (Z)ⁿ⁺represents ammonium ion or a cation derived from an organic amine compounds or a basic dye; wherein n is 1 or 2, ml is an integer from 1 to 4 and K¹ is the ratio of m¹ n; and wherein formula [I-a] is: 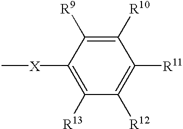
wherein X is O or NH, and R⁹ to R¹³, which may be the same or different, are independently selected from the group consisting of H, alkyl, aryl, alkenyl, alkoxy, amino, N-alkylamide, N-arylamide, hydroxy, halogen atom, acyl, acyloxy, acylamide, acyl-N-alkylamide, carboxyl, alkoxycarbonyl, or sulfonyl; wherein at least one of R¹ to R⁸ and R⁹ to R¹³ is sulfonyl group; and wherein formula is [II]: 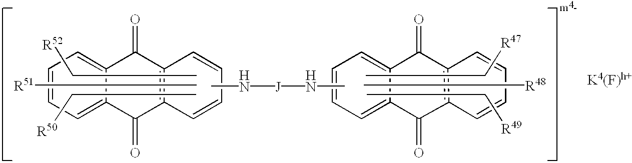
wherein R⁴⁷ to R⁵², which may be the same or different, are independently selected from the group consisting of H, alkyl, aryl, alkenyl, alkoxy, amino, N-alkylamide,N-arylamide, hydroxy, halogen atom, acyl, acyloxy, acylamide, acyl-N-alkylamide, carboxyl, alkoxycarbonyl, or sulfonyl; and at least one of R⁴⁷ to R⁵² is of sulfonyl; and
Formula J in formula [II] is selected from formula [II-a] or formula [II-b] and binds two anthraquinone,
Wherein the formula [II-a] is: 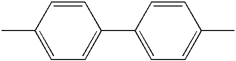
and wherein the formula [I-b] is: 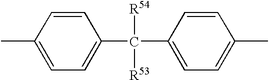
wherein R⁵³ to R⁵⁴, which may be the same or different, are independently selected from the group consisting of alkyl(having 1 to 8 carbon atoms) or hydrogen; and wherein (F)^{h+}represents ammonium ion or a cation derived from an organic amino compounds or a basic dye wherein h is 1 or 2, m⁴ is an integer from 1 to 4 and K⁴ is the ratio of m⁴/h.

13. The composition of claim 12, where in the laser-transmitting black colorant suitable for being mixed with a thermoplastic resin comprising at least amine salt of anthraquinone dyes of formula [I] where as at least one of R⁹, R¹⁰, R¹, R¹² and R¹³ of formula [I-a] is sulfonyl group.
